(19) United States
(12) Patent Application Publication
(10) Pub. No.: US 2005/0135677 A1
(43) Pub. Date: Jun. 23, 2005

(54) Method and apparatus for acquiring image data from a scanned document

(76) Inventors: Timothy S. Seevers, Lexington, KY (US); Joel S. Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/744,408

(22) Filed: Dec. 22, 2003

(51) Int. Cl. G06K 9/00; G06K 9/34; G06K 9/62; G06K 9/78

(52) U.S. Cl. 382/165; 382/176; 382/195; 382/209

(57) ABSTRACT

A method of acquiring data from an image wherein the image has an image attribute. The method includes the acts of identifying a zone that has the image attribute, and acquiring data from the identified zone.

### BACKGROUND OF THE INVENTION

The present invention relates to a scanner for converting paper-based documents into electronic image data, and more particularly to a method and apparatus for processing the image data.

In a typical workflow process, data on medium such as paper is often transitioned into a digital image format such that useful information can be acquired from the image. Exemplary data types include text, signature information, social security number, facsimile numbers, and the like. However, acquiring useful information from an image is generally a time consuming and expensive process, which involves significant storage and processing resources.

For example, after a page has been scanned, information from the entire scanned page is available. In order to access the information, a system must search all image data for any significant content. If the image data is in color, the search process can require even more storage and processing power because even more data needs to be read and analyzed. The processes of searching for and processing significant information are generally not fully automated. In other words, user interaction is often required in these processes. However, manually tagging specific areas of image data to limit processing areas is also a time consuming and a labor-intensive process.

### SUMMARY OF THE INVENTION

Accordingly, there is a need for an improved and automated process to acquire data from an image. The present invention thus provides a method of acquiring data from an image. In general, the image includes an image attribute. In one form, the method includes the acts of identifying a zone that has the image attribute and acquiring data from the identified zone.

In another form, the method includes the acts of determining a search attribute for the image, identifying a zone of the image that has the search attribute, and acquiring data from the identified zone.

The present invention also provides a method of processing a scanned image. In one form, the method includes the acts of searching for a color from the scanned image and processing a zone of the scanned image that has the color.

The present invention also provides a data acquisition system for acquiring data from an image that has an image attribute. In one form, the system includes an attribute identifier that identifies a zone, which has the image attribute and a data acquisition processor that acquires data from the identified zone.

Other features and advantages of the invention will become apparent to those skilled in the art upon review of the following detailed description, claims, and drawings.

### BRIEF DESCRIPTION OF THE DRAWINGS

In the drawings:

FIG. 1 shows a block diagram of a data acquisition system for acquiring data from an image according to the present invention; and

FIG. 2 shows a flow chart of a data acquisition process for acquiring data from an image according to the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the term “coupled” and variations thereof herein are used broadly and encompass direct and indirect connections and couplings. In addition, the term “coupled” and variations thereof are not restricted to physical or mechanical connections or couplings.

### DETAILED DESCRIPTION

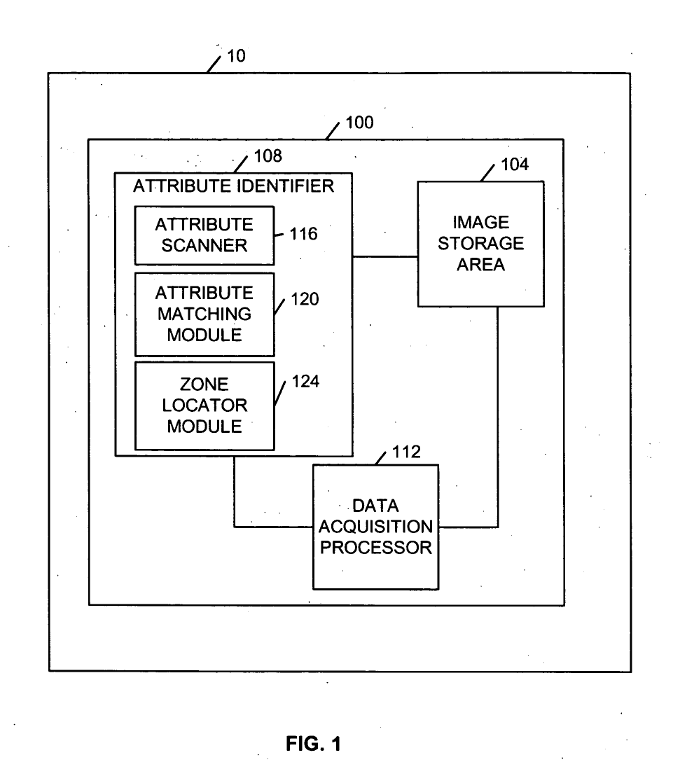

FIG. 1 shows a block diagram of a scanner 10 embodying the present invention. The scanner 10 can be a dedicated document scanner, or a multi-function unit such as a copier/scanner, or an all-in-one unit such as a printer, scanner, copier, and facsimile combination device. The scanner 10 can include a data acquisition module or system 100 for acquiring data from an image. The data acquisition system 100 can include an image storage area 104, an attribute identifier 108, and a data acquisition processor 112. In some embodiments, the image storage area 104 can be a sensor buffer, or a memory, and the image is a scanned image or a digital image. The scanner 10 generally has a standard image resolution, and the image resolution will generally define a number of sensors used in the scanner 10. In some embodiments, there can be a total of about 7,650 sensors used in the scanner 10. In other embodiments, there can be a total of about 5,100 sensors used in the scanner 10. The scanned image data generally consists of at least one row of pixels. Each pixel has a color that can be represented by a bit depth. For example, the bit depth can be 24 bits, 30 bits, and 36 bits long. It will be appreciated that other bit depths can also be used in the data unit.

Once an image has been scanned, initial scanned image data can be stored in the image storage area 104. The initial image data will generally include some image attributes such as color. Background color, background watermarks, font size, font color, font style, font effect, and the like are some other exemplary image attributes. It will be appreciated that different forms of the scanned image data can be used. For example, an entire scan object can be stored as the scanned image data in one embodiment. In such a case, the entire scan object is stored in the storage area 104. In other embodiments, only data from a row of sensors can be stored in the storage area 104. In yet other embodiments, the storage area 104 can also be configured to include rows of sensors used in the scanner 10. Typical sensors include contact image sensors (“CIS”), and charged-coupled devices (“CCD”).

Once the image has been sensed, scanned and stored in the storage area 104, the attribute identifier 108 may start to identify at least one location or zone in the image that has an image attribute. In one embodiment, the attribute identifier 108 algorithmically identifies or locates a zone in which the image attribute matches a predetermined or default search attribute such as background color. In general, information such as background color is available in each byte of image data. For example, if a scanned image data set is a row-ordered data set that contains at least one byte of scanned image data, given a color scan data set S, the attribute identifier 108 will search set S byte-by-byte, and row-by-row for a match to a search color or attribute. Specifically, an attribute scanner 116 will scan for a predetermined image attribute, such as background color, in the initial image data. If the search attribute is color, the attribute scanner 116 will be configured to scan for colors in the scanned image data.

Thereafter, an attribute-matching module 120 can determine if the initial image data contains the predetermined image attribute. Once the attribute-matching module 120 has determined that there is an attribute match, a start of a zone can be located, and data contained in the zone can be stored in a buffer for further processing. Specifically, when the initial image data contains the predetermined image attribute, a zone locator module 124 can be generate a corresponding zone, byte location, or a set of coordinates of the image where the attribute match occurred. The data of the identified zone can be subsequently processed at the data acquisition processor 112. For example, the data acquisition processor 112 can perform character recognition on the data of the identified zone.

When the attribute match has stopped, an end of the zone (or an end zone) is located. Particularly, the end zone can be established when an end of a row is reached or by a contiguous stream of non-color matches that exceed a predefined tolerance. The zone identifier 108 can continue to search until all zones are identified within the scanned image data. Once all the zones are identified, the identified zones can be checked to determine if any of the zones are within a predefined page proximity of each other. If the zones are within the predefined page proximity of other zones, the zones are combined into a single zone containing both sets of image data. In this way, adjacent zones with appropriate data can be combined for accurate processing. Once all adjacent zones are combined, the process 200 will result in a minimum number of zones found within the color scan data set.

In another embodiment, the attribute identifier 108 can first identify or scan for all image attributes contained in the initial image data at an attribute scanner 116. Once the attribute scanner 116 has identified the attributes contained in the initial image data, the zone locator module 124 can generate a plurality of corresponding zones of the image where the attributes are identified. The data of the identified zones can be subsequently processed at the data acquisition processor 112. Although all image attributes contained in the initial image data can be identified, other numbers of image attributes can also be identified. For example, the data acquisition system 100 can be configured to identify two attributes of the image. Furthermore, although the attribute identifier 108 and the data acquisition processor 112 are primarily software based modules, dedicated hardware such as application specific integrated circuits (“ASICs”) can also be used to implement all or part of either one, or both of the modules 108, 112.

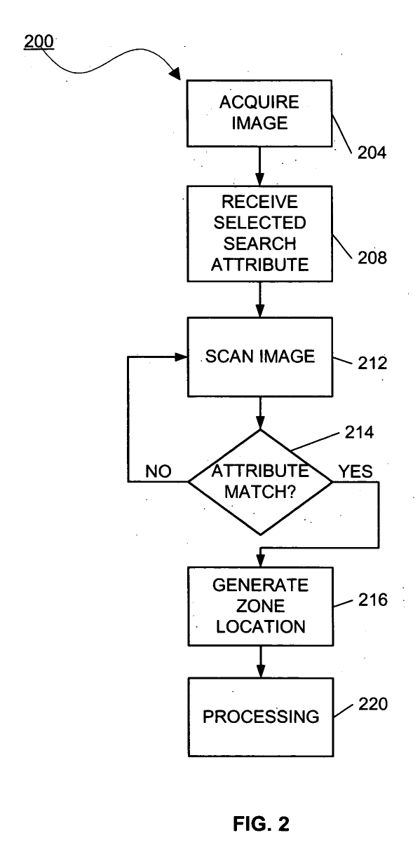

FIG. 2 shows a flow chart of a data acquisition process 200 from an image according to the present invention. Once an image has been acquired (for example, from scanning) and stored in the storage area 104 (FIG. 1) at block 204, the data acquisition system 100 can provide a list of search attribute options, and each of the search attribute options characterizes a search attribute. As a result, when a search attribute option is selected by the user, a search attribute selection can be sent to and received by the data acquisition system 100 at block 208. After a search attribute has been selected and determined, the data acquisition system 100 (FIG. 1) can scan the acquired image for image attribute that matches the search attribute at block 212 with the attribute identifier 108. Particularly, when there is an attribute match in the image, as determined at the attribute matching module 120, a zone location can be determined or generated at block 216 with the zone locator module 124. The zone location can be a set of coordinates at which the matched attributes are located. In other embodiments, the zone location can also be memory locations at which the attributes are matched. Once the zone location has been determined, the data acquisition system 100 can determine if there are adjacent zones to merge with, or process with, the identified zone. Specifically, the image data contained in the zone location can be processed at block 220 with the data acquisition processor 112.

In one embodiment, a particular pre-printed form may contain a specific color for automatic character recognition processing. For example, Form 1040 of the Internal Revenue Service (“IRS”) may include a social-security number block pre-printed in a pre-determined color, such as blue, while other blocks of the form do not contain a color background. The data acquisition system 100 can thus be configured to locate or search for areas or zones of the image of the form that contain image attributes such as blue background. When the blue background has been identified at the attribute scanner 116, a blue zone can be located at the zone locator module 124. Thereafter, data processing techniques such as automatic character recognition can be used to process the data in the zone to identify the social security number at the data acquisition processor 112. In such a case, the processing techniques such as automatic character recognition can only process a portion of the image. It will be appreciated that even though the social-security number block is generally pre-printed in a relative constant location, the data acquisition system 100 can also be configured to scan for zones that are located in different areas of the scanned image, detailed hereinafter.

In some embodiments, different colors may also be used to initiate different actions at processing block 220. For example, multiple forms with varying formats may all have a social security block that is either highlight blue or surrounded by a blue box. Furthermore, each of the forms may contain a section for an applicant city surrounded by a red box. After images of the forms have been acquired and stored in the image storage area 104, the data acquisition system 100 will route data with different attributes to different routines of the data acquisition processor 112 for dedicated processing. For example, data with blue background or blue boxed data may be routed to a first routine of the data acquisition processor 112 such as an optical character recognition program to extract the social security numbers. Meanwhile, the red boxed address may be routed to a second routine of the data acquisition processor 112 to update a total count of received forms from the particular city. Similarly, the data acquisition system 100 can also be configured to securely acquire data and route the data for specific secure processing. For example, certain data areas can only be processed with specific parts of the data acquisition processor 112. In this way, users with a specific given data acquisition processor authorization can be able to process a selected area of the image with a specific image attribute.

In another embodiment, the search attribution selection block 208 shown in FIG. 2 may skipped or omitted. Instead, the data acquisition system 100 may scan for and store all the image attributes of the image at block 212. The data acquisition system 100 may also scan for and store image attributes corresponding to predetermined, preset or default image attributes. In such cases, the image may have at least one image attribute, and a number of zone locations may be generated at block 216. The zone locations may identify zones in which image attributes have been identified. The data contained in the identified zones may then be acquired or processed at block 220 with the data acquisition processor 112. The embodiment may therefore result in identifying one or more of the zones that represent a change in color within the image.

In such embodiments, more than one zone can be identified automatically, and the number of zones is dynamic. For example, a pre-printed form may have three sections, with each section having a unique color. When the form has been completed, the raw initial image data may be stored in the data acquisition system 100. The data acquisition system 100 may thus be configured to search for three different colors in the raw image data. In this way, the data acquisition system 100 may search through all raw scan data and return three zone locations corresponding to the three sections of the form.

In an embodiment wherein the zone locations are relatively inconsistent, the data acquisition system 100 as described can also be configured to search and locate such zones by color or other search attribute. For example, Form A can have a blue signature block in a lower left quadrant of a page. Form B can have a blue signature block in an upper right quadrant. After images of Forms A and B have been acquired, the data acquisition system 100 may search the image of the forms for the signature blocks and return the located zones for processing.

Instead of a pre-printed form or material with pre-set indicators, such as colored blocks, a user may also create zones “on the fly” or “ad hoc” by selecting, highlighting or otherwise indicating the desired portions of a page. For example, the user may use a colored highlighter to highlight a section on a form or a newspaper article, for example, and scan in the form or the newspaper. In another embodiment, the data acquisition system 100 can be configured to provide a variety of color options, to the user. Once a search color has been selected, the data acquisition system 100 can then scan the acquired image for locations with a background having the search color. Once the locations with search color background have been obtained, data in those locations can be extracted and processed at block 220.

Various features and advantages of the invention are set forth in the following claims.

1. A method of acquiring data from an image and processing the data based on the existence of an image attribute, the method comprising the acts of:
identifying a zone having the at least one image attribute; and
acquiring data from the identified zone.

2. The method of claim 1, wherein the image comprises a scanned image.

3. The method of claim 1, wherein the image comprises a digital image.

4. The method of claim 1, wherein the image attribute comprises at least one of color, font size, font color, font style, and font effect.

5. The method of claim 1, wherein the act of identifying the zone further comprises the acts of scanning the image for all image attributes, and identifying a zone location of the image for each of the scanned attributes, the zone location being configured to represent a zone corresponding to at least one image attribute.

6. The method of claim 1, further comprising the act of determining a search attribute.

7. The method of claim 6, wherein the act of identifying the zone further comprises the acts of determining at least one image attribute from the image; scanning the image for an image attribute that matches a search attribute; and identifying a zone location in the image when the image attribute matches the search attribute.

8. A method of acquiring data from an image and processing the data based on the existence of an image attribute, the method comprising the acts of:
determining a search attribute for the image;
identifying a zone of the image corresponding to or matching the search attribute; and
acquiring data from the identified zone.

9. The method of claim 8, wherein the image comprises a scanned image.

10. The method of claim 8, wherein the image comprises a digital image.

11. The method of claim 8, wherein the search attribute comprises at least one of color, font size, font color, font style, and font effect.

12. The method of claim 8, wherein the act of determining the search attribute for the image further comprises the acts of
providing a plurality of search attribute options, each search attribute options characterizing a search attribute; and
receiving at least one selected search attribute option.

13. The method of claim 8, further comprising the acts of
scanning the image for the image attribute that matches the search attribute selected; and
generating a zone location when the image attribute matches the search attribute selected.

14. A method of processing an image, the method comprising the acts of
scanning the image for an image color; and
processing a zone of the image having the image color.

15. The method of claim 14, wherein the image color comprises a background color of the image.

16. The method of claim 14, wherein the image color comprises a font color of the image.

17. The method of claim 14, further comprising the acts of
providing a list of search colors; and
receiving a selection of at least one search color.

18. The method of claim 17, and further comprising the acts of
scanning the image for the search color selected; and
identifying a location in the image when the search color selected matches the image color.

19. The method of claim 14, and further comprising the act of identifying a zone location for the color.

20. A scanner including a data acquisition system for acquiring an image and processing image data based on the existence of an image attribute, the system comprising:
an attribute identifier configured to identify a zone having the at least one image attribute; and
a data acquisition processor coupled to the attribute identifier and configured to acquire data from the identified zone.

21. The system of claim 20, wherein the image comprises a scanned image.

22. The system of claim 20, wherein the image comprises a digital image.

23. The system of claim 20, wherein the image attribute comprises at least one of color, font size, font color, font style, and font effect.

24. The system of claim 20, wherein the attribute identifier further comprises an attribute scanner configured to scan for the image attribute of the image; and a location identifier configured to identify an image location for each of the scanned attributes.

25. The system of claim 24, wherein the attribute identifier further comprises an attribute matching module configured to match the scanned attribute with a search attribute.
